(19) United States
(12) Patent Application Publication
(10) Pub. No.: US 2008/0101647 A1
(43) Pub. Date: May 1, 2008

(54) FULL-RANGE SPEAKER DEVICE

(76) Inventor: Cheng-Yuan SUN, Linyuan Township (TW)

Correspondence Address: LEONG C LEI, PMB # 1008, 1867 YGNACIO VALLEY ROAD, WALNUT CREEK, CA, 94598, US

(21) Appl. No.: 11/550,810

(22) Filed: Oct. 19, 2006

(51) Int. Cl. H04R 9/06; H04R 11/02; H04R 1/00

(52) U.S. Cl. 381/407; 381/396

(57) ABSTRACT

A full-range speaker device is provided herein that can deliver high-fidelity trebles. The major feature of the present invention lies in that the voice coil is sandwiched between two or more concentric bobbins. As such, out of the same back-and-forth movement of the bobbins, different ranges of sounds are produced through separate bobbins by the diaphragms attached to the bobbins, respectively.

### TECHNICAL FIELD OF THE INVENTION

The present invention generally relates to full-range speakers or loudspeakers, and more particularly to a full-range having multiple bobbins.

### DESCRIPTION OF THE PRIOR ART

FIG. 1 is a schematic sectional view showing a conventional full-range speaker device. As illustrated, the speaker device contains a bobbin 1 where a voice coil 11 is wound around the circumference thereof. The circumference of the bobbin 1 is then attached to and positioned in the center of a spider 2, a bass diaphragm 3, a mediant diaphragm 4, and a treble diaphragm 5 sequentially in this order from the voice coil 11. When electrical current is conducted through the voice coil 11, a magnetic field is produced and interacts with that of a permanent magnet around the bobbin 1 (not shown) to cause the bobbin 1 to move back and forth accordingly. The bass, mediant, and treble diaphragms 3, 4, and 5, are thereby vibrated to produce sound waves covering all ranges of audible sounds.

The disadvantage of the foregoing design is as follows. As the diaphragms 3, 4, and 5 are all glued to the same bobbin 1, the treble diaphragm 5 which is the farther away from the voice coil 11 along the bobbin 1 usually delivers blurred and fuzzy high-pitch sounds under the influence and damping of the bass and mediant diaphragms 3 and 4. Therefore, to achieve high-fidelity sounds, conventionally multiple speakers each dedicated to a specific range of sounds are provided, which not only is costly but also requires an amplifier of much higher power.

### SUMMARY OF THE INVENTION

The primary purpose of the present invention is to provide, a full-range speaker device that can economically deliver high-fidelity trebles. The major feature of the present invention lies in that the voice coil is sandwiched between two or more concentric bobbins. As such, out of the same back-and-forth movement of the bobbins, different ranges of sounds are produced through separate bobbins by the diaphragms attached to the bobbins, respectively. Crystal high-pitch sounds are therefore achieved by the present invention.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic sectional view showing a conventional full-range speaker device.

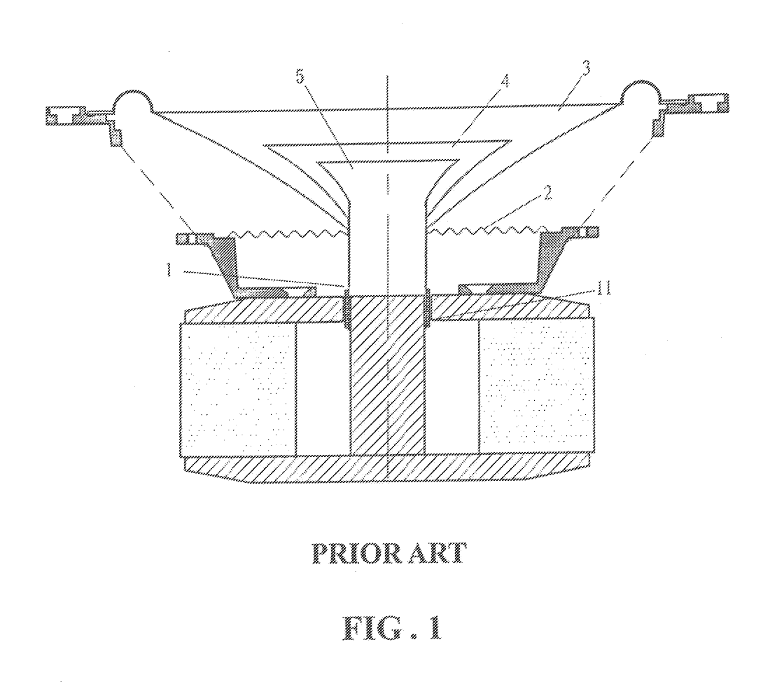

FIG. 2 is a schematic sectional view showing a full-range speaker device according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

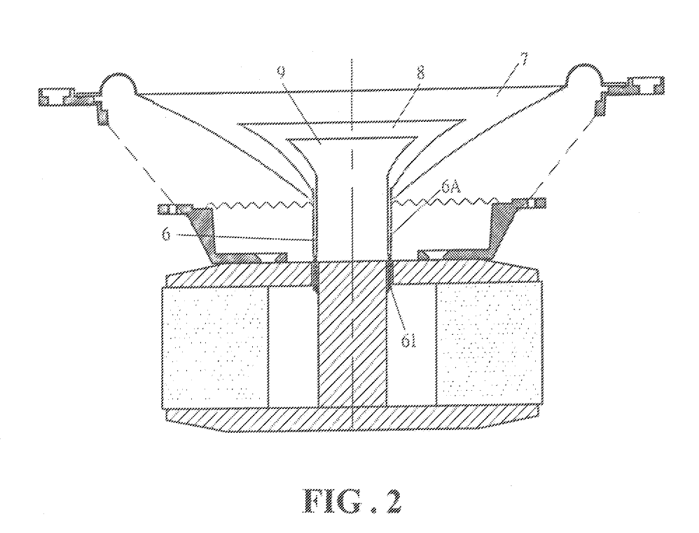

FIG. 2 is a schematic sectional view showing a full-range speaker device according to an embodiment of the present invention. The basic structure of the present invention is similar to the prior arts in that the circumference of a first bobbin 6 is wound by a voice coil 61. The major difference lies in that at least a concentric second bobbin 6A is configured around the voice coil 61, thereby housing the first bobbin 6 inside. A treble diaphragm 9 is attached to and positioned in the center of the inner first bobbin 6 while the bass and mediant diaphragms 7 and 8 are attached to and positioned in the center of the external second bobbin 6A. Please note that an appropriate gap is preserved between the first and second bobbins 6 and 6A, as shown in FIG. 2, above the voice coil 61.

The advantage of the present invention results from the provision of the two or more bobbins. When electrical current is conducted through the voice coil 61, the high-pitch sounds are produced by the treble diaphragm 9 through the inner first bobbin 6 while lower-pitch sounds are produced by the bass and mediant diaphragms 7 and 8 through the outside second bobbin 6A. In other words, by the same mechanical movement of the bobbins 6 and 6A, different ranges of sounds are delivered by separate diaphragms. Crystal, high-pitch sounds therefore can be produced without the influence of lower-pitch sounds. In an alternative embodiment, a second voice coil can be provided and wound around the circumference of the second bobbin 6A so as to provide more power in driving the two bobbins 6 and 6A.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A full-range speaker device, comprising:
a first bobbin attached to and positioned in the center of a treble diaphragm;
a second bobbin coaxially around said first bobbin, said second bobbin attached to and positioned in the centers of a bass diaphragm and a mediant diaphragm; and
a first voice coil sandwiched between said first and second bobbins;
wherein an appropriate gap is preserved between said first and second bobbins.

2. The full-range speaker device according to claim 1, further comprising a second voice coil wound around said second bobbin.
